(19) United States
(12) Patent Application Publication
(10) Pub. No.: US 2022/0128838 A1
(43) Pub. Date: Apr. 28, 2022

(54) HINGE FOR AN EYEGLASSES FRAME

(71) Applicant: HARTER S.R.L., Belluno (IT)

(72) Inventors: Eric BALZAN, Belluno (IT); Roberto DA RIN BIANCO, Belluno (IT)

(21) Appl. No.: 17/423,158

(22) PCT Filed: Jan. 16, 2020
(86) PCT No.: PCT/IB2020/050328

§ 371 Date: Jul. 15, 2021

(30) Foreign Application Priority Data
Jan. 17, 2019 (IT) 102019000000709

(51) Int. Cl. G02C 5/22

(52) U.S. Cl. CPC G02C 5/2209; G02C 5/146

(57) ABSTRACT

A frame of eyeglasses lens is described comprising a ring, to accommodate the perimeter of the lens, with two free clampable ends for closing the ring and tightening it around a lens. a temple rod (50) and a hinge for the rod (50) formed by a hooked or curved portion, comprised at an end of the rod (50), configured to slidingly grip onto the outer surface of the first member.

The invention relates to a hinge for an eyeglasses frame.

Notoriously eyeglasses are assembled using small screws, especially for hinges connecting the two temple rods to the front piece.

The front piece is normally used to accommodate one (in the case of a mask) or more (in the case of eyeglasses) lenses. For this purpose, the front pieces of rigid, for example metallic, eyeglasses normally have openable rings suitable for accommodating the lenses, and able to be closed to firmly block the lenses in the frame.

In most eyeglasses the temple rods, when they are not used, close thanks to a hinge.

Often the hinge is composed of an element fixed by welding, riveting, gluing, embedding or screwing to the so-called “muzzle” of the front piece; and another element to the temple rod. The assembly of these elements takes place by means of screws, which also allow the rotation of the two halves of the hinge.

However, this configuration has disadvantages, e.g. difficulty of managing small parts in the production phase and the obligation to use specialized machinery, normally present only in production or industrial or laboratory environments.

In addition, the screws tend to loosen because they are the rotation center of the hinges, so they must be periodically tightened.

To avoid maintenance, for years the challenge has been active in the market to look for hinges without screws, see e.g. TWM446910U or WO2015173678, with the disadvantage however of having a complex and/or not very robust structure. All the elements must be built and assembled with centesimal dimensional tolerances, and require both specific tools for assembly as well as careful training for the assembly and disassembly operator. In the case of TWM446910U, a failure of the temple rod would result in the opening of the ring with loss of the lens. Some models (see DE102004027012, element 4 in the drawings) provide for the insertion of an additional element with respect to the hinge to firmly close the ring.

Eyeglasses are often a medical device in which the ease of assembly of the lens by the specialized operator (often an optician) and its solidity over time is of great importance, considering that the structure of the eyeglasses is subject to numerous stresses.

Improving this state of the art is the main object of the invention, which is defined in the appended claims, wherein the dependent ones define advantageous variants.

Another object is to propose a front piece of eyeglasses with stable fixing for the lens.

Another object is to propose a simple and effective locking system for eyeglasses ear frames.

Another object is to propose a hinge for eyeglasses that is easy to assemble and resistant to use.

Another object is to propose a fixing system between the front piece of the eyeglasses and a temple rod.

A frame for a eyeglasses lens is proposed comprising

a ring, for accommodating the perimeter of the lens, having a free end,

a first and second element which can be connected together to tighten said free end, wherein the first element is equipped with
a slot, which may or may not be pass-through (the first element is equipped e.g. with a blind slot), in which to insert said end and
a surface access shaped so that through it the second element, by only a linear translation along an axis, can be inserted inside the first element for reaching a position in which it cooperates with said end for locking the latter inside the slot.

The aforementioned fastening system is very simple and easy to put into practice. An advantage is that the lens receives a uniform tension since the frame's ring can close completely.

Said ring may be e.g. non-deformable and closed, to accommodate the lens without adjustment. In a preferred variant, which envisages for adjustment of the tightening of a lens into the ring, said end of the ring consists of two free ends lockable to close the ring and tighten it around a lens.

Through said only linear translation the second element can be inserted inside the first element to reach a position where it cooperates with at least one of said ends to lock them into the slot.

In a preferred variant, said access comprises threaded walls on which a surface thread provided on the second element can be screwed to carry out said linear translation of the second element.

E.g. the second element is advantageously a screw or a threaded dowel, very simple and robust construction. In addition, in the variant in which the second element is screwable in the first one, there is the advantage of simplifying the lens mounting by a user with a simple screwdriver. The user does not need complex training or special manual skills in managing the lens disassembly and reassembly.

An advantage of the screw is that it can exert pressure in the same direction along which the ring is tightened around the lens. The screw exerts a closing pressure on said two ends ensuring a uniform pressure of the frame on the lenses.

Since the screw is not the hinge's rotation center, it is not subject to rotation and thus to unscrewing, and the assembled assembly of front piece+first element is very solid.

The second element, e.g. the screw, in a variant can be configured in such a way that, following said only linear translation along said axis, it presses on the two said ends to push them against the internal walls of the first element.

The second element, e.g. the screw, in a variant can be configured in such a way that, following said only linear translation along said axis, it divaricates the two said ends to push them in opposite directions against the internal walls of the first element.

The second element can also be an expansion nail, a welding point, an adhesive element or glue.

A great advantage of the invention is that the disassembly/assembly of the lens can also be carried out even when all the other elements of the eyewear remain connected to each other. It is enough to disconnect the second element (e.g. unscrewing the screw) from the first one and release the lower margin of the front piece, releasing the pressure of the ring on the lens.

In addition, this configuration allows mounting the lens in the ring separately from the temple rod. In the event that the temple rod comes off, the first element remains mounted, and the lens remains solid in the frame.

In a preferred variant, said access consists of a widening of the slot.

In a preferred variant, said access penetrates axially into the interior of the first element.

In a preferred variant, the first element comprises a base from which two parts separated by said slot project cantilevered, wherein the slot preferably is delimited by two walls parallel to each other of the two parts.

In a more preferred variant, said access is located at the free end of the two parts separated by said slot and extends inside the first element towards said base; in particular, the widening consists of a recess provided in each of the two parallel walls.

The above-mentioned spectacle lens frame may comprise a rod for a temple and a hinge for the rod, wherein the rod is coupled to the first element.

In a preferred variant, said access is placed at an intermediate point of the two parts separated by said slot and extends inside the first element parallelly to said parallel walls towards the center of the first element.

In a preferred variant, said base of the first element is a prism with polygonal base or plan.

In a preferred variant, said two parts separated by said slot comprise on their outer lateral surface a smooth band, which runs all around the first element.

In a preferred variant, the first element comprises surface facets to give the rod a snapping movement when the rod rotates on the first element during the closing movement (approaching the front piece). In a more preferred variant, the facets in the first element are in correspondence of said two parts separated by said slot, wherein the first element comprises a polygonal-based prism divided in half by the slot. The facets of the prism also gives a jerky movement of the rod on the first element during the closing movement (approaching the front piece.)

In a variant, the rod at one end thereof comprises a hooked or curved portion configured to grip slidingly to the external surface of the first element.

In a preferred variant, the rod comprises at one end thereof one or more bent prongs so that they permanently embrace—and can slide on—the outer lateral surface of the first element.

In a more preferable variant, the rod comprises a second curved prong to embrace and slide on the facets of the said polygonal-based prism and/or said base of the first element.

In an even more preferred variant, each of the first and the second prongs are curved so as to exhibit a concavity facing the other prong, thereby forming an overall structure to rotatably support the first element and/or to rotatably connect to the external surface of the first element.

A variant envisages that one or more prongs are configured to abut against the end of the ring when the angle between the rod and the front piece comprising the ring is greater than 90 degrees, so as to create an end-of-travel position for the maximum angular opening rotation of the rod.

In a more preferred variant, the smooth band and the polygonal-based prism are divided by a circular edge projecting from the external lateral surface of said two separate parts, in order to stabilize the rod and/or the his prongs.

In an even more preferred variant, the smooth band is placed between the polygonal-based prism and said base of the first element.

In a more preferable variant, the rod comprises a first prong curved so that it can embrace and slide on said smooth band.

Another variant envisages that the screw, or the second element, is inserted inside the first element through an access located on that base.

The parts of the frame are made of rigid and not deformable material (e.g. metal, carbon, rigid plastic), in particular along the X-axis.

Further variants envisage to use the first and/or second element as a beautifier, making in one or each of them a seat for screw application, or pressure or bayonet application or any other mode, of a third surface element, e.g. decorative or a chip.

Further variants envisage to use the first and/or second element as a support for a rod stabilization means, obtaining in one or each of said elements a seat for screw application, or pressure or bayonet fitting or any other way, of the stabilization means. E.g. the stabilization means may be a disc or a plate, integral to the base of the first element, of such size that it protrudes from the perimeter of the first element to constitute a fence or an abutment for the rod and/or a prong thereof.

Preferred embodiments of the front piece and hinge of eyeglass will now be described in detail with the help of the attached drawings in which

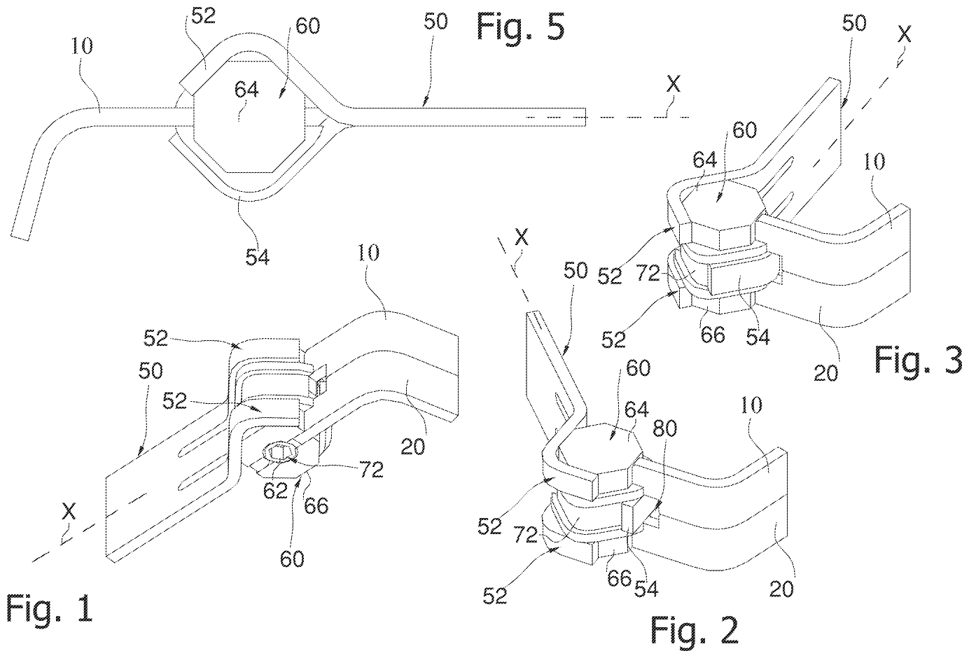

FIG. 1 shows a three-dimensional view from below of a hinge for eyeglasses;

FIG. 2 shows a different three-dimensional view from above the hinge in FIG. 1 with different opening;

FIG. 3 shows a view as FIG. 2 but with different opening;

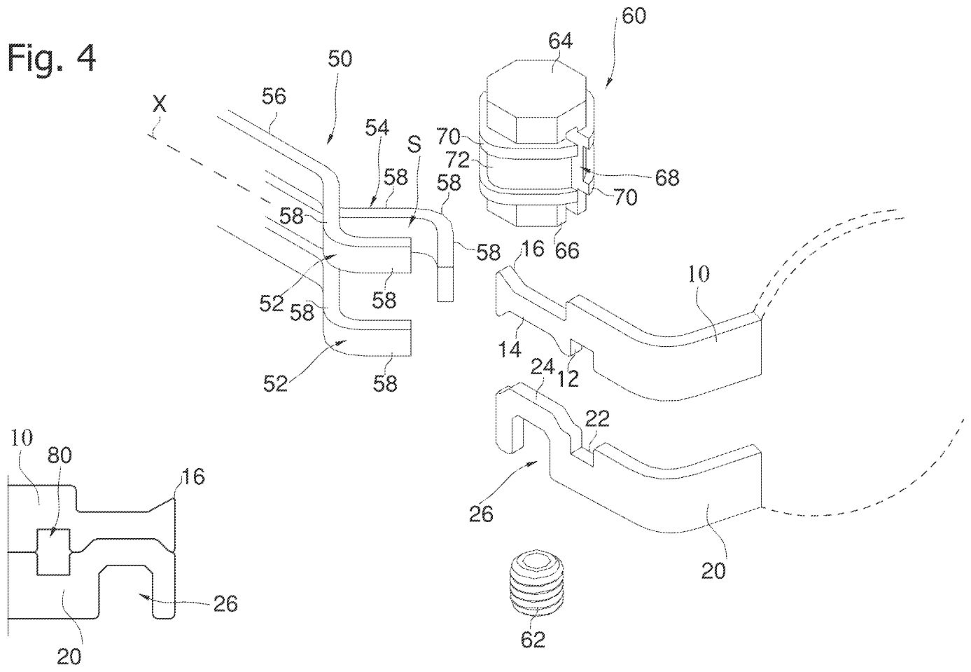

FIG. 4 shows a different exploded view of the hinge in FIG. 1;

FIG. 5 shows a top view of the hinge in FIG. 1;

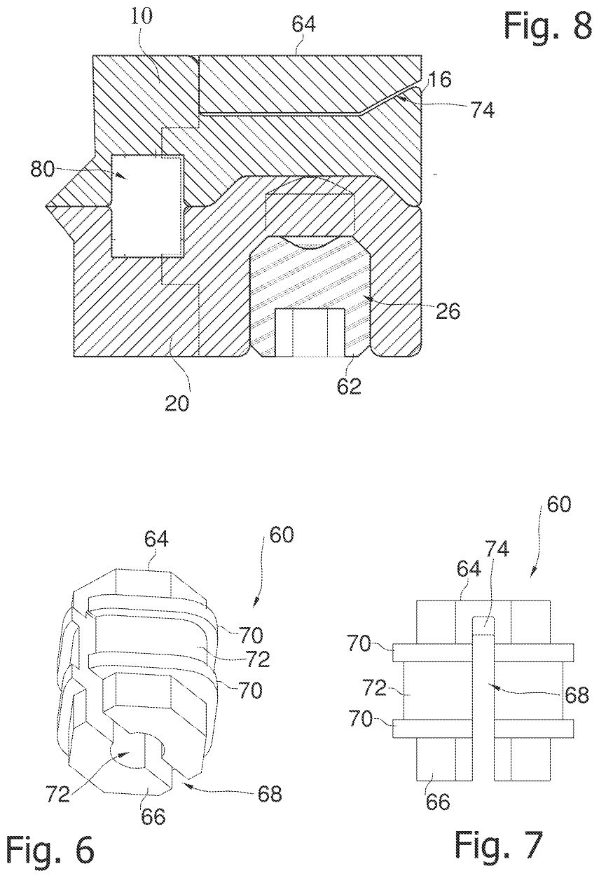

FIG. 6 shows a three-dimensional view from below of a component of the hinge in FIG. 1;

FIG. 7 shows a front view of the component in FIG. 6;

FIG. 8 shows a cross-sectional view according to planes IV-IV and VI-VI;

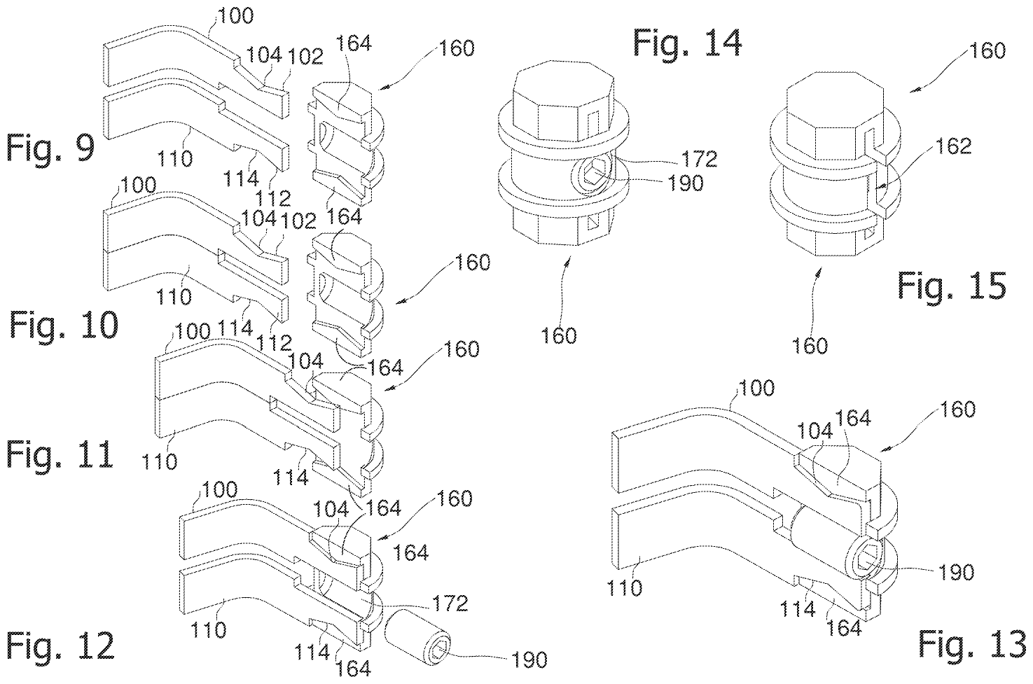

FIGS. 9-13 show a cross-sectional view of a variant for the fastening of a lens;

FIGS. 14-15 show three-dimensional views of opposite sides of a component.

In order not to crowd the figures too much, some references are omitted. Equal numbers indicate equal parts. The following components are described as in use.

FIGS. 1÷4 show the components of a hinge for eyeglasses, i.e. a rod 50 for the temple, a barrel 60 and the clampable ends 10, 20 of a circle enclosing a lens (not shown).

Here, as later on, for the invention the rod is optional, because the cooperation between the barrel 60 and the ends 10, 20 is sufficient to form an independent system for tightening the ends 10, 15 However, with the rod 50 the components advantageously cooperate more synergistically to form an advantageous hinge.

The ends 10, 20 are shaped so as to be able to be overlapped one on the other in a complementary way (see detail in FIG. 4) and avoid the sliding/translation of the ends at the expense of the tightness of the structure. The upper end 10 comprises a notch 12 on the lower edge and a concave surface 14; while the lower end 20 correspondingly comprises a notch 22 and a convex surface 24. When the ends 10, 20 are attached to each other, the notch 12 and the notch 22 match to form overall a pass-through opening 80, and the convex surface 24 leans on the concave surface 14. The convex surface 24 belongs to an arch that defines a recess 26, while a tooth 16 protrudes from the free end of the concave surface 14 in the direction opposite to the end 20.

The rod 50 comprises a body 56 elongated along an X axis and ending at one end with three curved prongs 52, 54. The two prongs 52 are preferably equal, separated from each other by a certain distance and exhibit a concavity turned towards the third prong 54. The prong 54 is specular to the first two with respect to the body 56 and has a concavity facing them. Each of the prongs 52, 54 is formed by the junction of two linear segments 58 which form a 90 degree angle. Altogether the prongs 52, 54 embrace—like “three prehensile fingers”—a square-plan space S inside which the barrel 60 can be housed snugly.

The barrel 60 is provided with a pass-through slot 68 which starting from the base divides it in the center into two equal halves joint by an upper portion 64 having a preferably octagonal plan. The slot 68 divides in half a central smooth band 72 and a second octagonal portion 66, with same plan as the first one, placed at the base of the barrel 60. The horizontal margins of the central band 72 are delimited by two protruding edges 70 which run parallel all around the barrel 60, with the function of stiffening the structure and avoid the detachment of the rod 50 from the barrel 60. At the center of the base of the barrel 60, at the axis thereof (see FIG. 6), the slot 68 has a threaded circular widening 72 for receiving with screwing a screw 62 along the axis of the barrel 60.

The threaded circular widening 72 constitutes a superficial access shaped so that through it the screw 62, by means of only a linear translation along a Q axis, can be inserted inside the barrel 60 to reach a position in which it cooperates with the ends 10, 20 to lock them inside the slot 68.

The barrel 60 is used to tighten the ends 10, 20 together.

The ends 10, 20 have the same width as the slot 68 and can be inserted in it when superimposed on each other (FIG. 7). Since the screw 62 has a diameter equal to the width of the recess 26, when it gets screwed into the widening 72 it ends up snugly inside the recess 26, where it prevents the ends 10, 20 from slipping off and pushes them against the portion 64. Such slipping off is also prevented by the interposition of parts created by the tooth 16 which abuts against an internal inclined plane 74 of the portion 64.

The barrel 60, fixed as described above to the ends 10, 20, can advantageously also be used to connect the rod 50 to the front piece of the eyeglasses.

The space S surrounded by the prongs 52, 54 corresponds to the volume of the barrel 60, so that they can support the barrel 60. For this purpose the prongs 52 are arranged so as to overlap—and be able to slide on—respectively the portion 64 and 66, and the prong, 54 is arranged so as to overlap—and being able to slide on—the central portion 72 (see FIGS. 1÷ 3 and 5). Thus, when the barrel 60 is inserted into the space S, the prongs 52 support one side thereof and the prong, 54 supports the opposite side.

When the rod 50 is opened or closed by moving it relative to the front piece (turning the X axis), the prongs 52, 54 slide on the barrel 60 without detaching, thanks also to their elasticity. The polygonal plan of the portions 64, 66 determines facets on the lateral surface of the barrel 60 on which the segments 58 of the prongs 52 can sequentially fit. Therefore the prongs 52 can only slide with snapping on such facets, following a slight manual effort, of the user who moves the rod 50, necessary to slightly widen the prongs 52 when, passing from one face to the other of the portions 64, they have to climb over the common edge. This has the advantage of maintaining the angular position of the rod 50.

To maximize the useful angle that the rod 50 can sweep, the free end of the prong 54 has such dimensions that it can pass through the opening 80 (FIGS. 2 and 3). This feature has the additional advantage of making the structure of the “closed” eyeglasses more resilient, namely when a deformation during non-use is more likely (e.g. eyeglasses in the pocket). The opening 80 may also have a different position and/or size to let a different prong or several prongs pass at the same time.

Advantageously the prongs 58 by construction are outside the rod 50 when the assembly is mounted, and they can abut against the outer surface of the ends 10, 20 if the rod 50 is turned excessively. Thus the prongs 58 cooperate with the outer surface of the ends 10, 20 to limit the maximum excursion of the rods 50 when they move away from the front piece.

Preferably the prongs 52 are made of elastic material (e.g. steel), so that their flexibility can determine a tolerance for the maximum opening of the rod 50, thereby making the structure flexible without compromising its solidity, and increasing the comfort of the wearing or facilitating the act of wearing/removing the eyeglasses from the face.

FIGS. 9÷15 show the components for a different tightening system for the ends 100, 110 of a ring for lens.

This system too can be advantageously exploited to add a hinge—not shown in figures. 9÷15—adapted for rotating a rod with respect to the lens-holding front piece, Such hinge may be e.g. as illustrated in the previous figures or even a hinge of a different type.

The ends 100, 110 are shaped to be able to overlap each other. The upper end 100 comprises a linear tip 102 with a concavity 104. The lower end 110 comprises a linear tip 112 with a concavity 114. The concavity 104 and the concavity 114 are facing opposite directions, while the tips 102, 112 extend parallel to each other.

When the ends 100, 110 are attached to each other, between the tips 102, 112 there creates an empty space thanks to two facing shoulders 108, 118 made on the tips 102, 112.

A barrel 160 is externally shaped like the barrel 60, and has a slot 162 that crosses it centrally without dividing it into two equal halves.

Inside the barrel 160, at the top and bottom edges of the pass-through slot 162, there are two wedges 164 pointing towards the center of the barrel 160.

In the center of the slot 162 there is a threaded hole or circular widening 172 to receive a screw 190 with screwing.

The ends 100, 110 have the same width as the slot 168 and can be inserted into it when superimposed on each other (FIG. 11 and FIG. 12). The elasticity of the tips 102, 112 causes the concavities 104, 114 to snap into place against the complementary wedges 164.

The threaded circular hole or widening 172 constitutes a surface access shaped so that through it the screw 190, by means of only a linear translation along an axis Q2, can be inserted inside the barrel 160 to reach a position in which it cooperates with the tips 102, 112 to spread them apart and lock them into the slot 172.

In other words, the screw 190 can be screwed into the barrel 160 parallel to the length of the tips 102, 112 until it locates between the tips 102, 112 inside the empty space formed by the shoulders 108, 118 (FIG. 13).

When the screw 190 is placed inside the empty space between the shoulders 108, 118, it prevents the points 102, 112 from flexing and uncoupling from the wedges 164. Thanks to the mechanical opposition of the screw 190 against the tips 102, 112, the ends 100, 110 remain integral with the barrel 160.

Note that the illustrated elements can have different shapes or structures, e.g.

the barrels may be completely cylindrical or with bases 64 with non-octagonal cross-section, e.g. with a circular or hexagonal or square base;

the front piece is divided into two parts but with the two parts connectable to each other in different way;

a different number of prongs on the temple rods;

different shapes for the prongs of the temple rods;

a different position in the barrel for the threaded hole that houses the screw;

different configuration of the ends 10, 20. Eg. there may be only one end to be fixed inside the barrel if the front piece is not a lockable ring to mount the lens.

1. Frame of eyeglasses lens comprising
a ring, to accommodate the perimeter of the lens, having an end consisting of two free clampable ends for closing the ring and tightening it around a lens.
a first and second member which can be connected to each other to tighten said free ends, wherein the first member is equipped with
a slot in which to insert said ends and
a surface access shaped so that through it the second member, by only a linear translation along an axis can be inserted inside the first member to reach a position in which it cooperates with said ends to lock the latter inside the slot;
a temple rods and
a hinge for the rod formed by a hooked or curved portion, comprised at an end of the rod , configured to slidingly grip onto the outer surface of the first member.

2. Frame according to claim 1, wherein said access comprises threaded walls on which a surface thread provided on the second member can be screwed to perform said linear translation of the second element, the second element being a screw or a threaded dowel.

3. Frame according to claim 1, wherein the second member is configured
in such a way that, following said only linear translation along said axis, it divaricates said two ends to push them in opposite directions against the inner walls of the first member, or
so that, following said only linear translation along said axis, it pushes on said two ends to push them against the inner walls of the first element.

4. Frame according to claim 1, wherein the first member comprises a base from which two parts separated by said slot protrude cantilevered, wherein the slot is delimited by two walls parallel to each other of the two parts, said access being placed at an intermediate point of the two parts separated by said slot and extending inside the first element parallel to said parallel walls towards the center of the first element.

5. Frame according to claim 1, wherein the first member comprises surface facets to give the rod a snap movement when it rotates dragging on the first member.

6. Frame according to claim 5, wherein the facets in the first member are in correspondence with said two parts separated by said slot, wherein the first element comprises a polygonal-base prism divided in half by the slot.

7. Frame according to claim 1, wherein said two parts separated by said slot comprise on the external lateral surface thereof a smooth band that runs all around the first element.

8. Frame according to claim 9, wherein the smooth band and the polygonal-base prism are divided by two circular edges protruding from the external lateral surface of said two separate parts.

9. Frame according to claim 1, wherein the rod comprises a first and second prong so curved that each has a concavity facing the other, thereby forming altogether a structure for rotatably connecting in a sliding manner to the external surface of the first element.

10. Frame according to claim 9, wherein the rod comprises three prongs;
a first prong to slide on the band between the two protruding circular edges, and
a second and third prong having the same curvature to slide on the facets, the first prong being curved so as to present a concavity facing the curvatures of the second and third prongs.

11. Frame according to claim 1, wherein the free clampable ends are configured so that, when they are attached to each other, they fit together to form an overall pass-through opening,
a free end of a prong, in particular said first prong, having dimensions such that it can pass through the pass-through opening when the rod rotates with respect to the first element.

12. Frame according to claim 1, wherein one or more prongs are configured to abut against the end of the ring when the angle between the rod and the front piece comprising the ring is greater than 90 degrees, so as to create an end-of-travel position for the maximum opening angular rotation of the rod.

13. Frame according to claim 2, wherein the second member is configured
in such a way that, following said only linear translation along said axis, it divaricates said two ends to push them in opposite directions against the inner walls of the first member, or
so that, following said only linear translation along said axis, it pushes on said two ends to push them against the inner walls of the first element.

14. Frame according to claim 2, wherein the first member comprises a base from which two parts separated by said slot protrude cantilevered, wherein the slot is delimited by two walls parallel to each other of the two parts, said access being placed at an intermediate point of the two parts separated by said slot and extending inside the first element parallel to said parallel walls towards the center of the first element.

15. Frame according to claim 5, wherein said two parts separated by said slot comprise on the external lateral surface thereof a smooth band that runs all around the first element

16. Frame according to claim 15, wherein the smooth band and the polygonal-base prism are divided by two circular edges protruding from the external lateral surface of said two separate parts.
